(19) United States
(12) Patent Application Publication
(10) Pub. No.: US 2007/0068587 A1
(43) Pub. Date: Mar. 29, 2007

(54) Slidable valve for fluid flow line

(76) Inventors: David S. Utterberg, Seattle, WA (US); William J. Schnell, Libertyville, IL (US); David Bell, Grayslake, IL (US)

Correspondence Address: Garrettson Ellis;Seyfarth Shaw LLP, Suite 4200, 55 East Monroe Street, Chicago, IL, 60603, US

(21) Appl. No.: 11/240,922

(22) Filed: Sep. 29, 2005

(51) Int. Cl. F16K 1/00

(52) U.S. Cl. 137/872

(57) ABSTRACT

A rotary valve for a fluid flow line comprises a valve tube having at least one lumen for unobstructed fluid flow of the fluid flow line therethrough. The valve tube has at least one side aperture communicating with the lumen. A housing is provided which is sealingly and rotatably mounted on the exterior of the valve tube. The housing defines at least one lateral port which registers with the side aperture in a first rotational position of the housing, while the lateral port is sealingly and rotationally spaced from the side aperture in a second rotational position of the housing. Preferably, the lumen is unobstructed and open in every rotational position of the housing.

### BACKGROUND OF THE INVENTION

In the field of fluid handling, and especially in the medical field, tubular flow-through sets are provided, for example IV administration sets, arterial and venous blood sets for hemodialysis, and sets for blood collection, plasmapheresis, and other uses. Typically, a flow-through set has one or more branch lines extending from a fluid flow line, which may be a main fluid flow line, or a branching line off of some other main flow line. The branching lines typically have a flow control device attached to them, such as a slide clamp or a roller clamp, which controls flow through flexible tubing. Alternatively, a rotary valve such as a three-way valve is sometimes provided to control flow through branching lines. For example, Loo U.S. Pat. No. 6,158,467 shows a four-part, four way stopcock for intravenous use.

In accordance with this invention, a simple, inexpensive flow control member is provided for one or more flow conduits that branch off of a fluid flow line, so that selective branching flow can be provided, while preferably never obstructing flow through the main fluid flow line.

### DESCRIPTION OF THE INVENTION

In accordance with this invention, a rotary valve for a fluid flow line is provided. The valve comprises: a valve tube having at least one lumen for unvalved fluid flow of the fluid flow line therethrough. The valve tube has at least one side aperture communicating with the lumen.

Also, a housing is provided, which housing is sealingly and rotatably or longitudinally slidably mounted around the exterior of the valve tube. The housing defines at least one lateral port which registers with the at least one side aperture in a first rotational position of the housing. The same lateral port is sealingly and rotatably or slidably spaced from the side aperture in a second position of the housing. Thus, flow is open or closed through the lateral port depending upon the rotational or slidable position of the housing.

In some embodiments of this invention, a female luer may connect with the lateral port carried by the housing. The female luer may be a conventionally-sized luer slip or luer lock connector, which may advantageously have an outer end that is closed by a needle pierceable, resealable rubber closure. This rubber closure is typically manually removable. Thus, substantially aseptic connection may be made with the female luer by a hollow needle which penetrates the resealable rubber closure, or by a male luer simply by removal of the rubber closure, which opens the female luer to connection.

In some embodiments, by this invention, a lateral port extending through the housing may connect with an outwardly extending branching port which is carried on the housing, and may be a luer as previously described. The valve tube may carry a hinged closure cap, which is proportioned to close the outer end of the branching port, when the lateral port is positioned in a second rotational position. This second rotational position is a no-flow position, with the lateral port being sealingly and rotationally spaced from the side aperture in the second rotational position.

The branching port, for example, may comprise a male or female luer, or any other desired tube. The hinged closure cap may comprise a sterility protector of either a sealing or a vented design.

A plurality of lateral ports may be provided, and/or a plurality of side apertures may be provided, with various lateral ports registering with various side apertures in any desired combination, in a manner dependent upon the rotational or slidable position of the housing. The housing is proportioned to provide good sealing with the valve housing. In some embodiments, the valve tube is made of generally rigid material, and the housing is made of a more resilient material, to promote such sealing. A lubricant or sealing grease may be used to aid both sliding and sealing.

The lumen of the valve tube is open in every rotational position of the housing. Thus, the rotary valve of this invention is preferably capable of opening and closing one or more branching connections to the fluid flow line, but the fluid flow line itself preferably remains fully open and flowing through the rotary valve in all circumstances.

For example, the rotary valve of this invention may have only a single lumen, a single side aperture, and a single lateral port present, as shown in an embodiment below. However, if desired, the rotary valve of this invention may have a single lumen, a single side port, and a plurality of spaced, lateral ports present, so that branch lines connected to the spaced, lateral ports may be selectively opened by appropriately rotating or sliding the housing.

If desired, the valve tube may have a wall which defines a flow channel that communicates between two spaced, lateral ports on said housing in one rotational position of the housing, but the channel is in communication with no aperture on the housing such that the flow channel between the housing and housing is spaced and sealed from the separate, flow through lumen of said housing. Thus, flow can take place between two lateral ports without being in flow communication with the lumen.

In another embodiment, the housing may be spring-biased to longitudinally space the lateral port from the side aperture. The housing is then manually and longitudinally slidable, with or without rotation, to permit the housing and the side aperture to register in the first position and to not register in a second, longitudinally spaced position. A plurality of side apertures and/or lateral ports may be present and respectively subject to this relationship or, if desired, some of the lateral ports and side apertures may register together in one longitudinally slideable and/or rotational position, and others may register together in another longitudinally slideable and/or rotational position of the housing.

Thus, a great deal of simple, effective flow control is provided to branching flow paths, while flow through the main flow path may not be restricted.

The rotary valve of this invention may be connected to opposed lengths of typically flexible tubing and sealed in flow relationship thereto, to form at least part of a medical fluid flow set: for example, an arterial or venous blood set for use in hemodialysis.

### DESCRIPTION OF THE DRAWINGS

FIG. 1 is an elevational view of one embodiment of the rotary valve of this invention.

FIG. 2 is a perspective view of the valve of FIG. 1, shown as part of a fluid flow set by connection at both ends with plastic flow tubing.

FIG. 3 is a plan view of the rotary valve of FIG. 1.

FIG. 4 is a sectional view taken along line 44 of FIG. 3.

FIG. 5 is an elevational view of the valve of FIG. 1, with the housing rotated to a different, closed position

FIG. 6 is a perspective view of the valve of FIG. 5.

FIG. 7 is a plan view of the valve of FIG. 5.

FIG. 8 is a sectional view taken along line 8-8 of FIG. 7.

FIG. 9 is an elevational view of another embodiment of the rotary valve of this invention, shown connected to a pair of set tubings.

FIG. 10 is a perspective view of FIG. 9.

FIG. 11 is an end view of FIG. 9.

FIG. 12 is a sectional view taken along line 12-12 of FIG. 11.

FIG. 13 is a plan view of another embodiment of the rotary valve of this invention.

FIG. 14 is a sectional view taken along line 14-14 of FIG. 13.

FIG. 15 is a plan view of the valve of FIG. 13, in a different rotational position.

FIG. 16 is a sectional view taken along line 16-16 of FIG. 15.

FIG. 17 is a plan view of the valve of FIG. 13, shown in yet another rotational position.

FIG. 18 is a sectional view taken along line 18-18 of FIG. 17.

FIG. 19 is a perspective view of yet another embodiment of the valve of this invention, comprising a modification of the embodiment of FIGS. 13-18, with a portion broken away.

FIG. 20 is a perspective view of yet another embodiment of the valve of this invention.

FIG. 21 is an end view of the valve of FIG. 20.

FIG. 22 is a sectional view taken along line 22-22 of FIG. 21.

FIG. 23 is an elevational view of the valve of FIG. 20.

FIG. 24 is a longitudinal sectional view of another embodiment of this invention, taken along line 24-24 of FIG. 25.

FIG. 25 is an end elevational view of the same embodiment.

FIG. 26 is a sectional view taken along line 26-26 of FIG. 24.

FIG. 27 is an enlarged detail taken from FIG. 24.

FIG. 28 is a perspective view of another embodiment of the invention.

FIGS. 29-32 are longitudinal sectional views of separate, added embodiments of this invention.

### DESCRIPTION OF SPECIFIC EMBODIMENTS

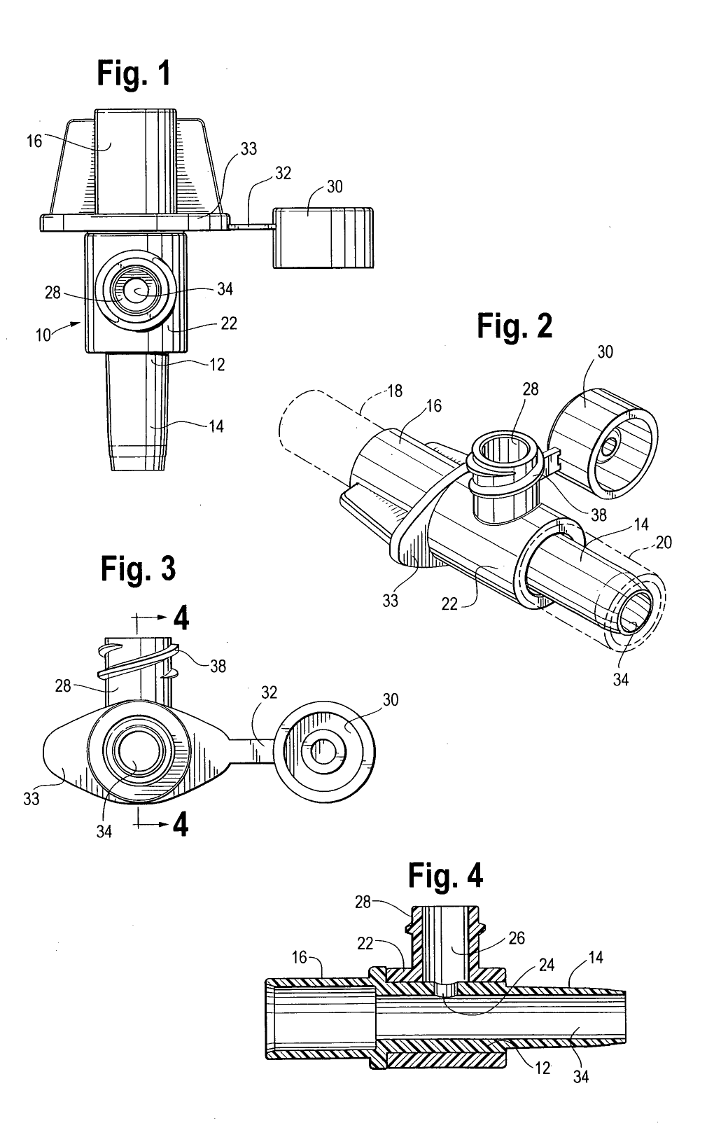

Referring to FIGS. 1-4, a first embodiment of the rotary valve 10 for a fluid flow line is shown. Valve 10 comprises a valve tube 12 that provides, at opposed ends, sites 14, 16 for receiving and bonding to flexible set tubing in a conventional manner. Tube connector 14 projects into the lumen of a length of flexible set tubing 20, while connector 16 defines a lumen into which flexible tubing 18 may extend. Both may be conventionally bonded with methyl ethyl ketone, or another suitable solvent or glue.

A housing 22 is sealingly and rotatably mounted on the exterior of valve tube 12. Valve tube 12 defines a side aperture 24 (FIG. 4) which is covered by rotatable housing 22. Housing 22 also defines a lateral port 26 defined, in this embodiment, by an outwardly projecting branching port 28, which is carried on housing 22, and may be a female luer lock connector. Branching port 28 may terminate with an outwardly facing aperture as shown, or branching port 28 may be angled after projecting outwardly for a distance, so that its open end faces generally parallel to the lengths of tubing 18, 20, if desired, in a manner similar to the branch tubes disclosed in U.S. Pat. No. 5,360,395.

Also, in this embodiment, valve housing 12 carries a closure cap 30, which is attached to a hinge 32 that is, in turn, attached to collar 33 of valve tube 12, and may be integrally molded therewith by conventional technology. Ribs 35 are to grip as housing is manually rotated.

Valve tube 12 defines a lumen 34 that is open, and unobstructed in any rotational position of the rotatable housing 22.

In the rotational position shown, as can be seen in FIG. 4, side aperture 24 and housing 22 are aligned in a first rotational position so that fluid flow can take place between the branching branching port 28 and lumen 34.

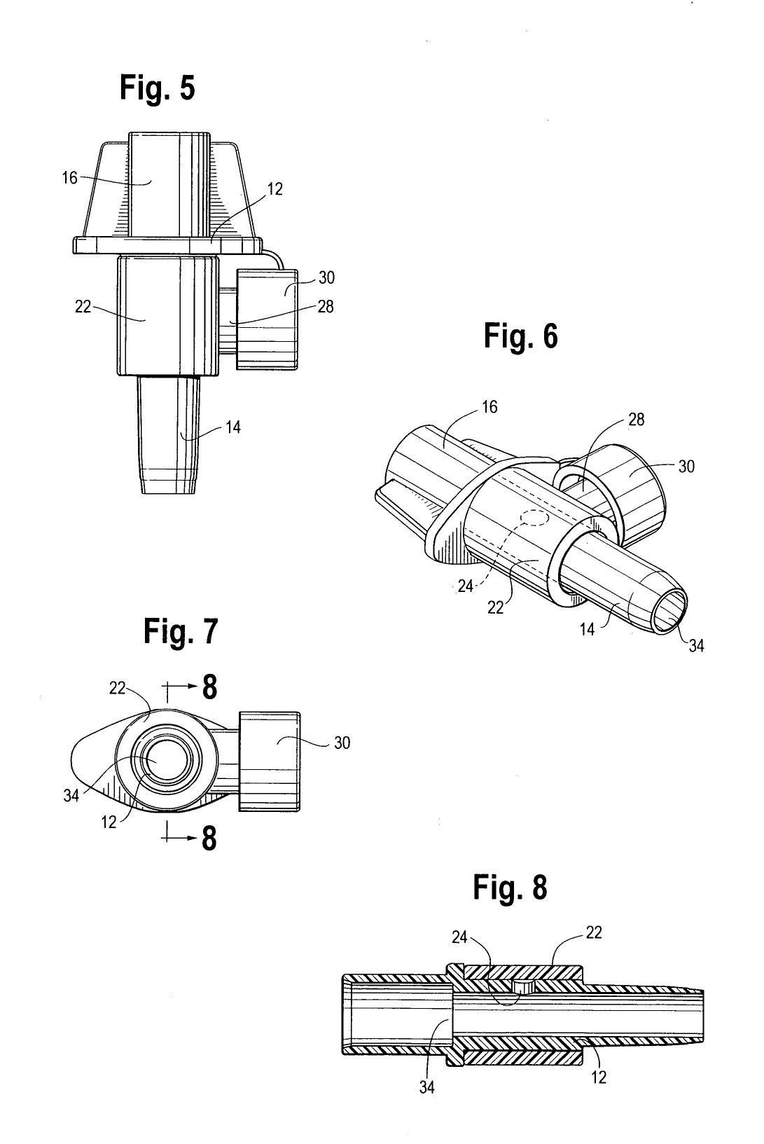

However, as shown in FIGS. 5-8, the same rotary valve has housing 22 rotated 90° to a different position where, as shown in FIG. 8, side aperture 24 and branching port 28 are rotationally spaced from each other so that no flow can take place through either member. Hinged cap 30 may be used to close the outer end of branching port 28, as shown in FIG. 6 in this particular, closed, rotational position.

Thus, by simple rotation of housing 22 on valve housing 12, flow access through branching port 28 into lumen 34 can be controlled, while lumen 34 remains open and unobstructed at any position of housing 22.

Branching port 28 carries a helical thread 38 (FIG. 2) on its exterior for appropriate connection with correspondingly threaded connectors.

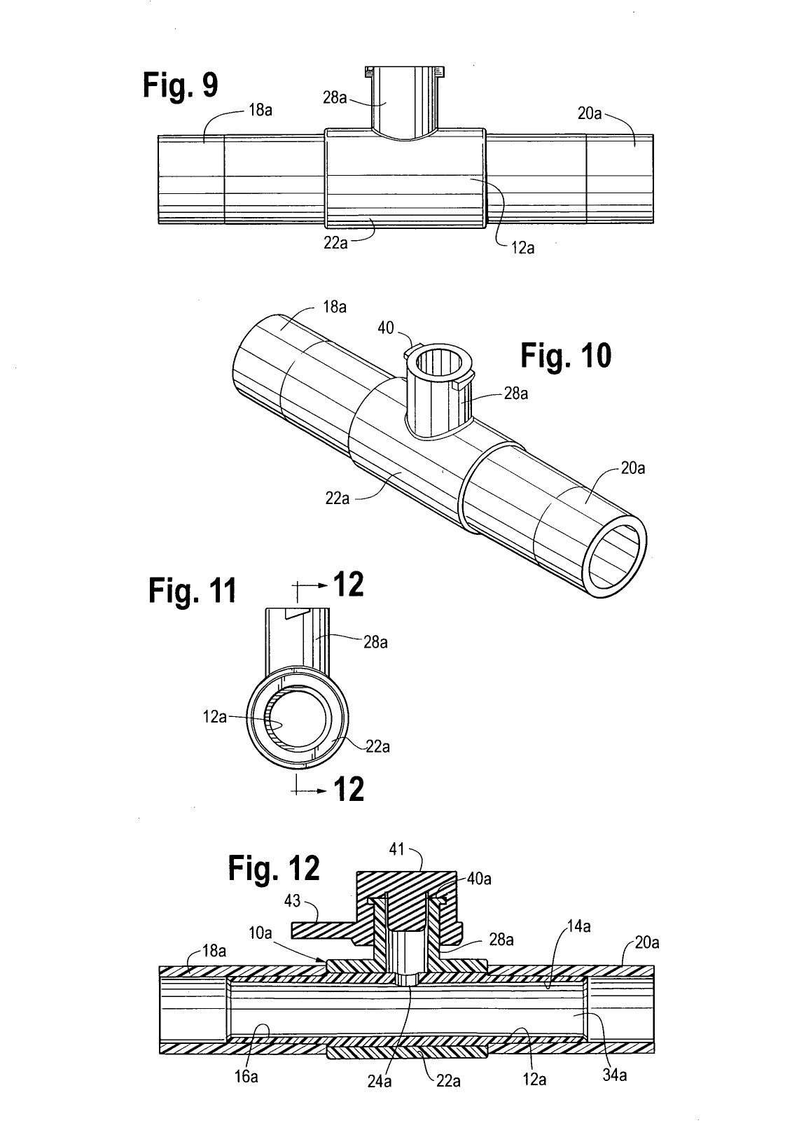

Turning to FIGS. 9-12, a similar design of rotary valve 10a is shown, having a tubular valve body 12a, which is attached to lengths of flexible set tubing 18a, 20a at opposed ends thereof, but in this embodiment the lengths of tubing 18a, 20a, both are on the outside of the tube attachment ports 14a, 16a. As before, valve tube 12a carries a housing 22a which, in turn, carries an outwardly extending branching port 28a, which may comprise a female luer lock connector in this embodiment, having conventional lugs 40 for connecting with a conventional male luer lock connector. Removable, resealable, needle penetrable closure 41 may also be provided, as in FIG. 12, having pull-off tab 43 to permit easy removal of closure 41 when connection with a male luer is desired.

FIG. 12 shows rotary valve 10a in the position where branching port 28a registers with side aperture 24a of valve housing 12a, to permit flow between branching port 28a and lumen 34a. However, it can be seen that if housing 22a is rotated, then branching port 28a goes out of registration with side aperture 24a, and access to lumen 34a through branching port 28a terminates, and the system is sealed by the frictional sealing action of housing 28a against valve housing 12a. Typically, valve housing 12a can be made of a material which is relatively rigid, while housing 28a is made of a material which is more resilient, to provide a good seal. Additionally, conventional sealing ribs and the like may be placed in the system.

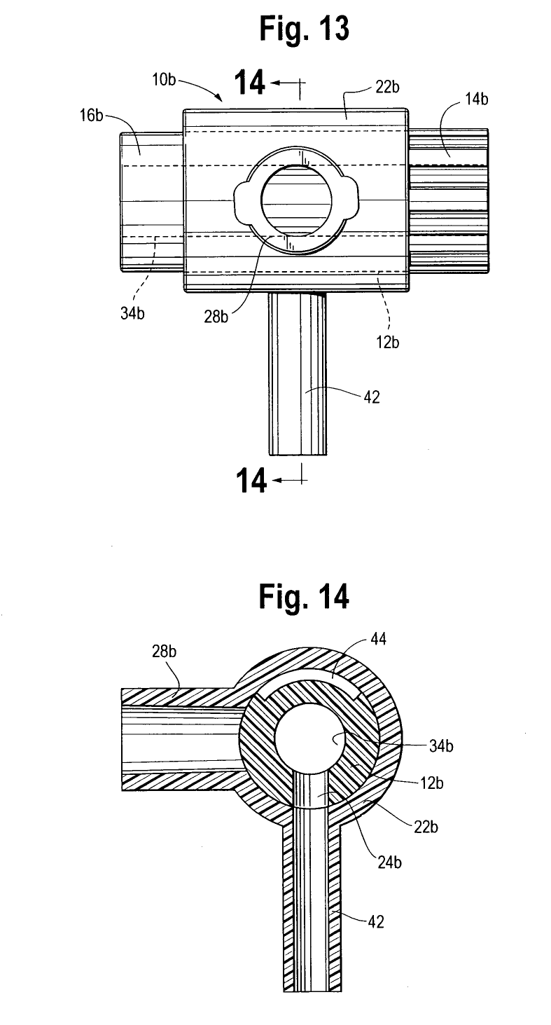

Referring to FIGS. 13-18, a third embodiment of rotary valve 10b is shown, the drawings respectively showing three different rotational positions of the valve.

As before, a valve tube 12b is shown, having terminal tubing lengths 14b, 16b projecting in opposed directions for attachment to appropriate flexible set tubing in a conventional manner, either inside or outside of the set tubing. Ribs 15 are for manual gripping as the valve is rotated. Rotatable housing 22b is provided as before, sealingly and rotatably mounted on the exterior of valve tube 12b. Also as before, valve housing 12b defines a side aperture 24b, communicating with lumen 34b of valve housing 12b.

However, in this embodiment, housing 22b carries a pair of spaced, outwardly projecting branching ports 28b, 42. Tube 28b may comprise a female luer, for example, while branching port 42 may comprise a straight tube for attachment to flexible tubing, in this particular embodiment.

As shown in FIG. 14, in the particular rotational position of FIGS. 13 and 14, flow communication between branching port 42 and main lumen 34b is provided, while flow through branching port 28b is blocked.

Also, a flow channel 44 is defined on the outer surface of valve tube 12b, but this particular channel 44 does not communicate with lumen 34b, and is closed and isolated in this particular rotary position shown in FIGS. 13 and 14.

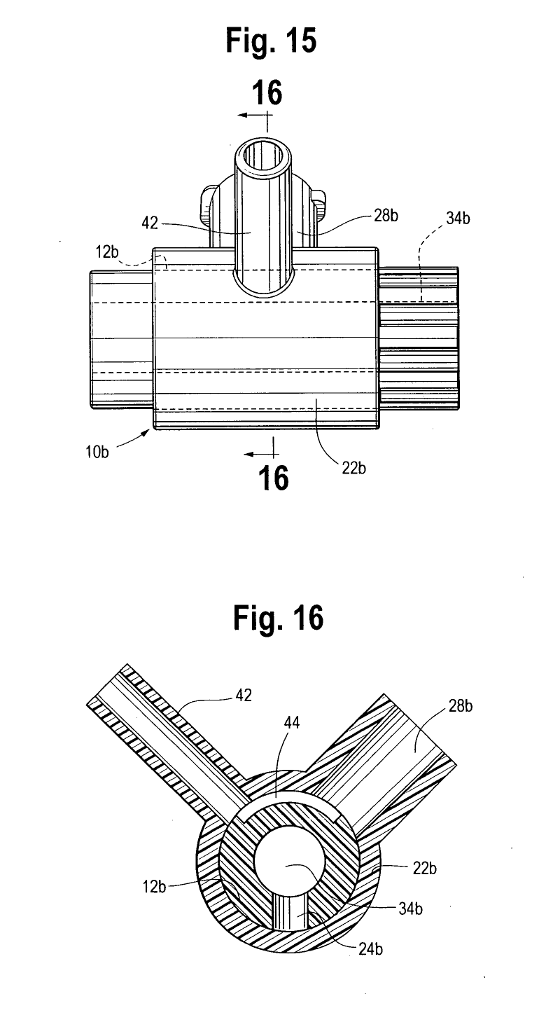

In FIGS. 15 and 16, the same rotary valve 10b is shown after housing 22b has been rotated about 120° clockwise, as shown by the transition from FIG. 14 to FIG. 16. In this rotational configuration, flow channel 44 provides flow connection between branching ports 42 and 28b, but this flow is out of flow communication with lumen 34b of valve housing 12b. In this position, side aperture 24b is blocked, and thus not used.

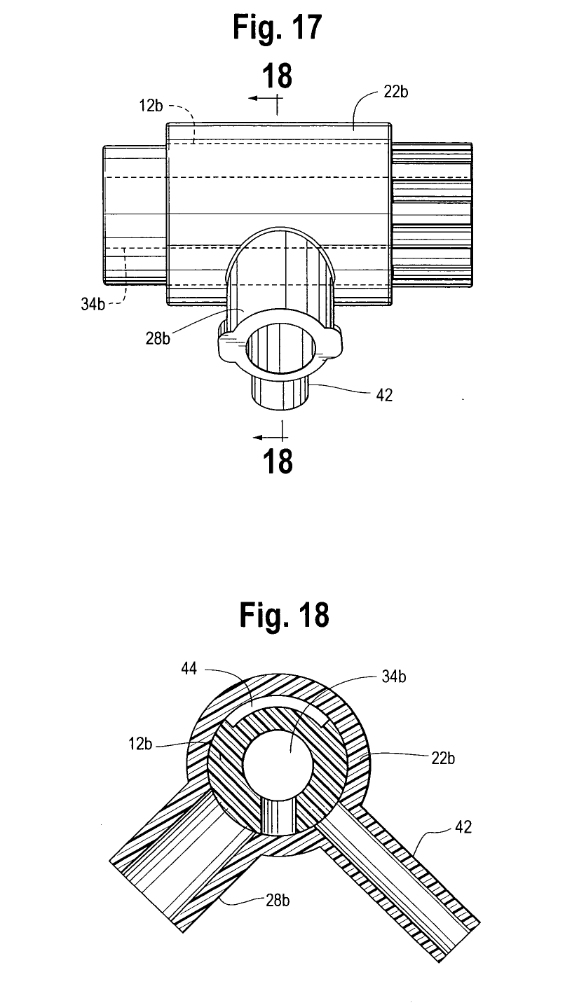

The rotary position of FIGS. 17 and 18 is 180° from the previous position of FIGS. 15 and 16. In this position, as shown by FIG. 18, all lateral connections are blocked, so that the only flow through the valve is through lumen 34b.

One can also note that a rotation of 90° counterclockwise from the position of FIG. 14 provides fluid flow access between branching port 28b and lumen 34b.

Further, it should be noted that in all rotational positions of housing 22b, lumen 34b is open and unblocked for unhampered fluid flow therethrough.

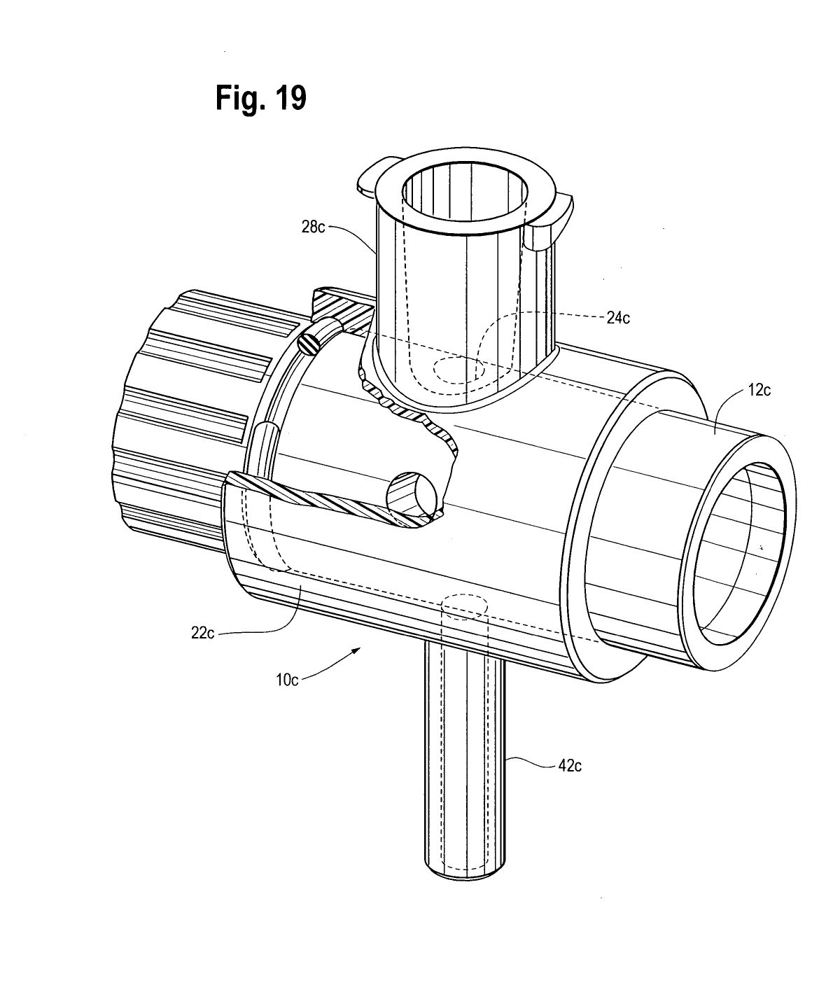

Turning to FIG. 19, another embodiment of rotary valve 10c is shown, which is substantially similar in structure and function to the rotary valve 10b of FIGS. 13-18, with the exception that branching port 42c is positioned 180° from branching port 28b, both being carried on housing 22c in a manner similar to the previous embodiments. Housing 22c is carried on valve tube 12c, which may be of a design similar to the previous embodiments, having at least one side aperture 24c, which may engage with either of branching ports 28c or 42c depending upon the rotational position.

If desired, more than one side aperture 24c may be present in any of the above embodiments. For example, a second side aperture 25 may be positioned 180° from side aperture 24c, if desired, to achieve selective fluid flow through both branching ports 28c, 42c at the same time. Then, another side aperture 27 could be positioned 90° from each of those side apertures, to provide selective opening of only one of the branching ports 28c, 42c as another option.

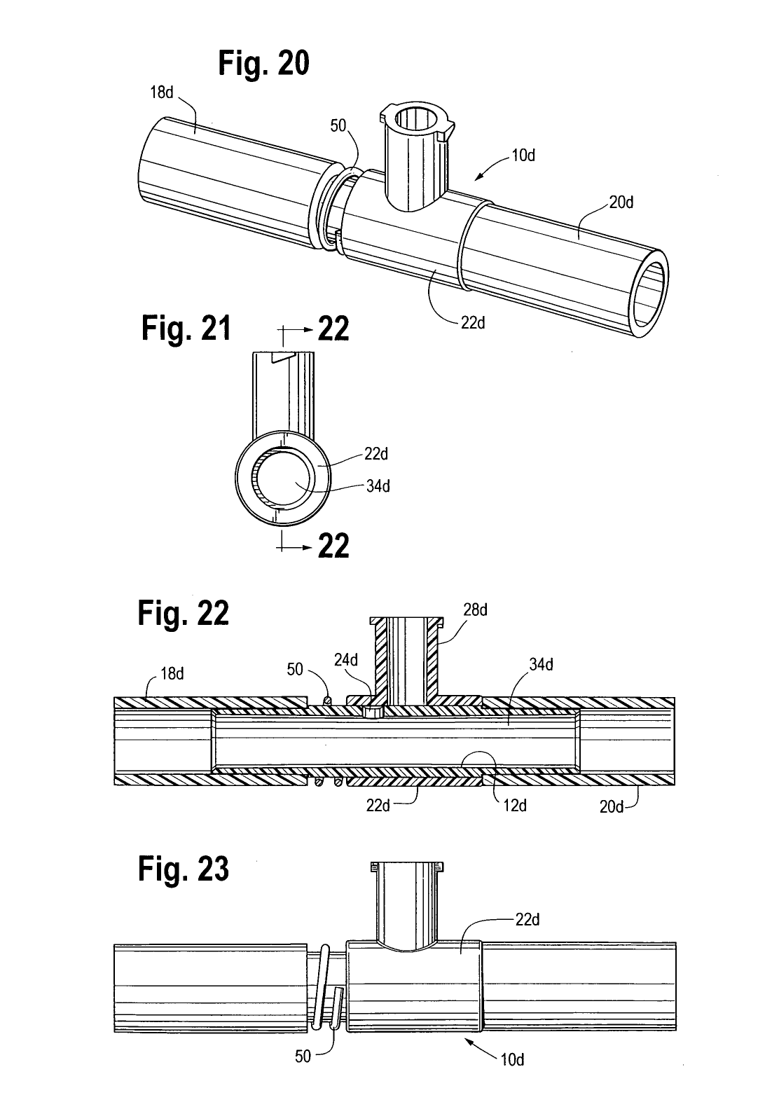

Referring to FIGS. 20-23, another embodiment of the rotary valve 10d of this invention is disclosed. As before, rotary valve 10d comprises a valve tube 12d upon which the housing 22d is rotatably and sealing carried. Valve housing 12d also defines at least one side aperture 24d as in previous embodiments. However, in this embodiment, housing 22d not only is rotatable relative to valve housing 12d, but it is longitudinally movable to an extent along valve housing 12d, being biased in one direction by a spring 50 to a position wherein side aperture 24d and branching port 28d are longitudinally spaced, so that they do not normally register in any rotational position of housing 22d as in FIG. 22. However, it is possible to manually move housing 22d to the right from the position shown in FIG. 22 to compress spring 50 and to bring branching port 28d and side aperture 24d into registry in the first rotational position of housing 22d. In some embodiments, a male luer may pass into branching port 28d, which may be in the form of a female luer, to slightly enter side aperture 24d, so that branching port 28d and side aperture 24d are held in registry by the presence of the tip of the male luer, providing flow communication between the male luer and lumen 34d of the main flow path.

Rotary valve 10d is shown to be connected at opposed ends with lengths of flexible tubing 18d, 20d, to comprise part of a flow set for blood or intravenous fluids for the administration of parenteral solutions, or for the extracorporeal treatment of blood, for example.

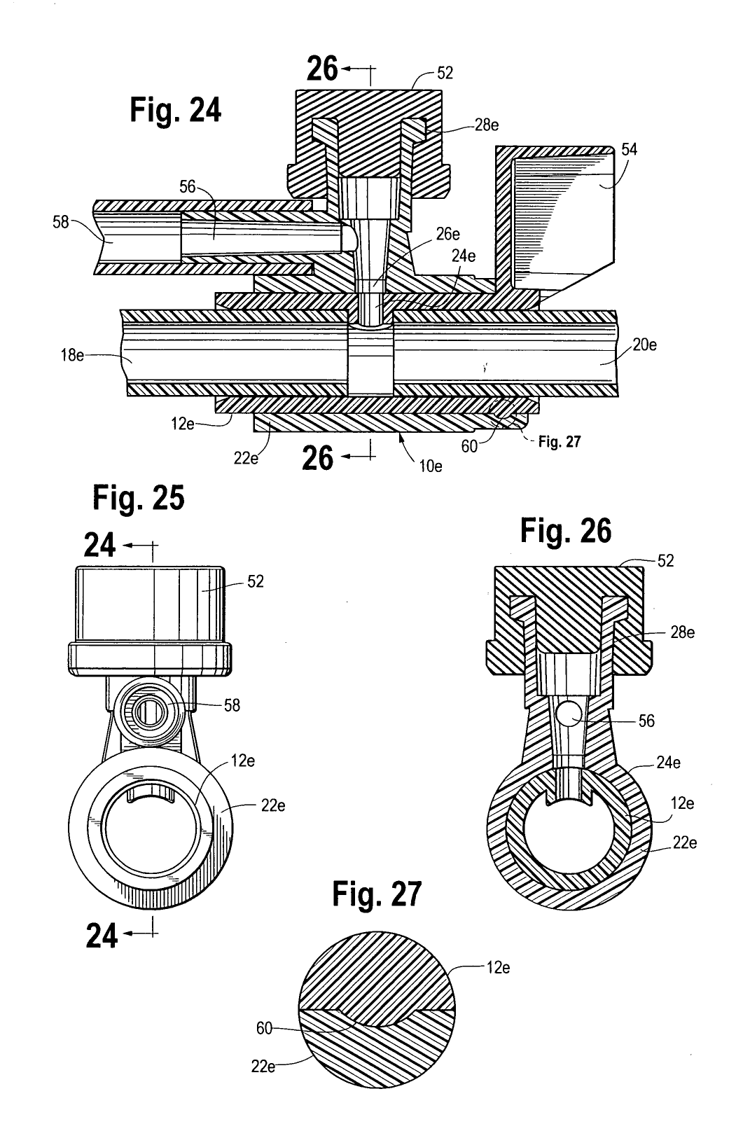

Referring to FIGS. 24-27, rotary valve 10e is shown having a valve tube 12e, similar to the previous embodiments. Housing 12e has a side aperture 24e as in the previous embodiments and a housing 22e surrounding valve housing 12e, also in a manner similar to the previous embodiments. Housing 22e has a lateral port 26e, and defines an integral, outwardly projecting branching port 28e which comprises an outwardly facing female luer. The female luer 28e, in turn, carries an elastomeric closure 52 of a generally known design, being of a type permitting resealable needle penetration into the lumen of lateral port 26e. Rubber closure 52 may carry a laterally projecting tab or other manually grippable structure to facilitate easy removal of closure 52, in a manner similar to tab 43 of FIG. 12 to facilitate removal of closure 52 in those circumstances where it is desired to make connection between female luer connector 28e and a male luer connector, either of the luer slip or luer lock type.

In this embodiment, manual handle 54 is shown to be attached to valve tube 12e. Accordingly, by manipulation of handle 54 housing 12e can be rotated to move side aperture 24e into or out of registry with lateral port 26e to open and close flow connection between the lumen of connected tubings 18e, 20e of a connected tubular flow set and lateral port 26e. Thus, flow communication with luer connector 28e can be opened or closed as desired by rotation of valve housing 12e and the attached tubings 18e, 20e.

Also, as can be seen from FIG. 24, a branching connector 56 branches off from lateral port 26e and connects with tubing 58, thus providing a branch line to the set which carries the rotary valve 10e of FIGS. 24-27.

Valve 10e can be maintained in the open position by a detent 60, which tends to hold the system in the open-flow position illustrated in FIG. 24, but which can still be easily rotated out of that position if desired.

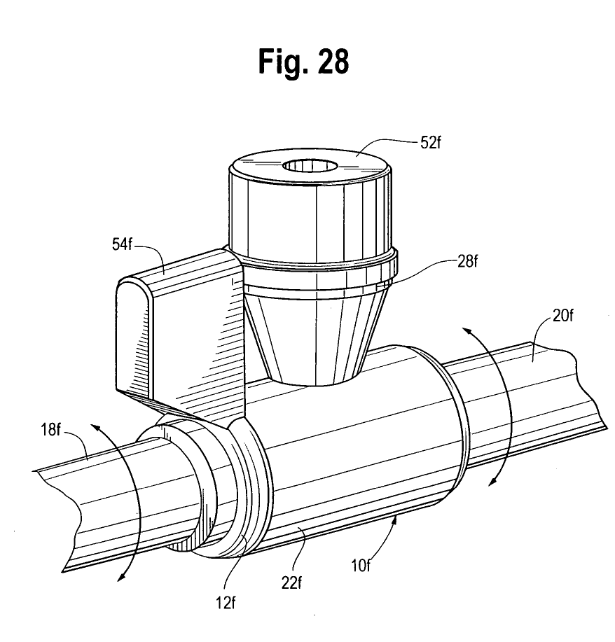

FIG. 28 shows a closely related rotary valve system 10f, which is essentially identical to valve system 10e of FIGS. 24-27, except that there is no branch line 56 and connected tubing 58. Housing 22f is visible, rotatably mounted with respect to a valve tube 12f, which is of essentially the same design as is seen in FIG. 24 for valve housing 12e, with tubings 18f, 20f being connected in similar manner to that shown in FIG. 24. Rotatable handle 54f is similar in structure and function to handle 54, rotating the valve tube relative to housing 22f. The connected female luer 28f and elastomeric closure 52f are also similar to the previous embodiment.

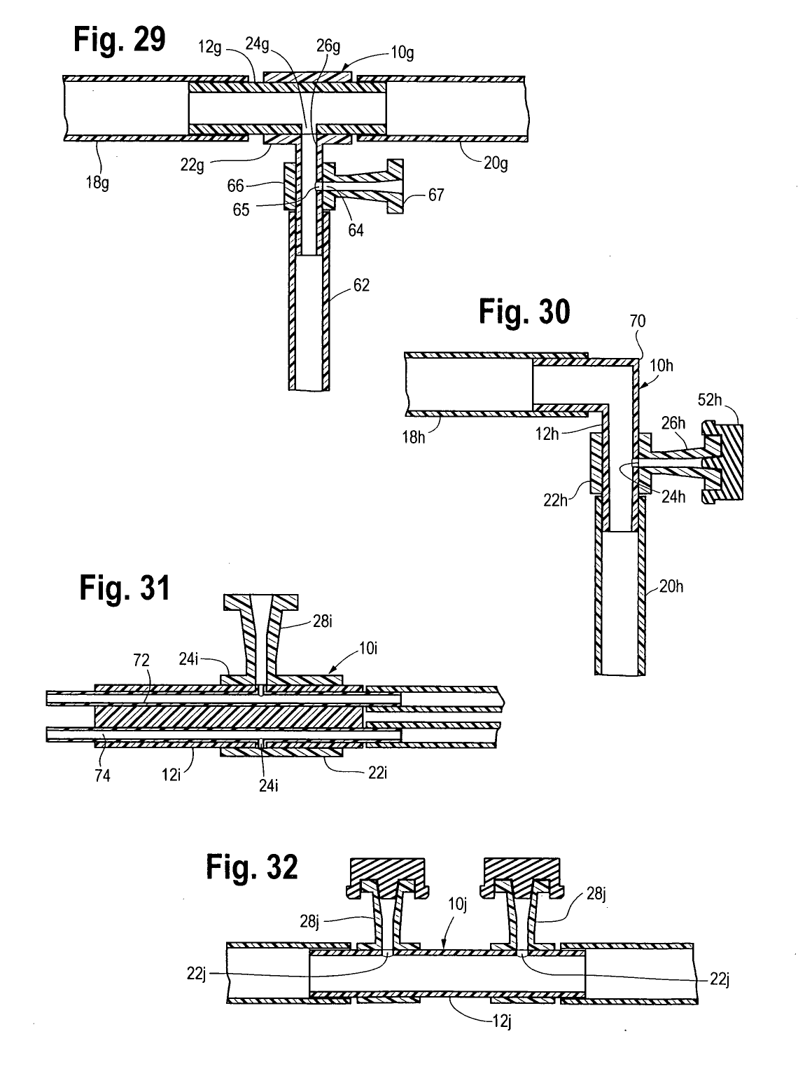

Referring to FIG. 29, in this embodiment of rotary valve 10g, valve tube 12g is shown, as in previous embodiments, to be connected with lengths of tubing 18g, 20g of a fluid flow set. Side aperture 24g is visible, as well as housing 22g, which rotates on valve housing 12g and carries a lateral port 26g which comprises an extending tube, connected with flexible tubing 62 and carries a side aperture 65. Positioned over side aperture 65 on tube 26g is another rotary sleeve 66 which, in turn, carries a lateral port 64 and luer connector 68.

Thus, lateral post 64 and luer connector 67 may be rotated with sleeve 66 into or out of registration with side aperture 65, to open and close the luer connector 68, while tubing 62 and 26g can be either opened or closed, depending upon the rotational position of housing 22g and rotary sleeve 66. Thus, a great deal of valving flexibility is provided by this embodiment.

Tubing 26g may terminate in a luer connector if desired, and luer 68 may be tubing, if desired.

Referring to FIG. 30, in this rotary valve system 10h, valve tube 12h comprises an angled bend 70, with the ends of valve tube 12h connecting to flexible tubing 18h, 20h, as in previous embodiments. In accordance with this invention, a housing 22h is rotatably mounted on valve housing 12h, and carries a luer connector as a lateral port 26h which can rotate into and out of registry with side aperture 24h, as in previous embodiments, to open and close connection with luer 26h. Also, an elastomeric, needle penetrable, removable closure 52h may be provided if desired.

Referring to FIG. 31, in this embodiment of rotary valve assembly 10i, the valve tube 12i comprises a pair of separate lumens 72, 74. Rotatable housing 22 has an outwardly projecting branching port 28i that comprises a luer connector at its outer end, and communicates in one rotatable position with side aperture 24i of one lumen 72, and in another position with side aperture 24i of the other lumen 74. Thus, branching access can be selectively made with two different flow paths through the same rotatable branching port 28i.

Referring to FIG. 32, rotary valve 10j comprises a valve tube 12j that carries a pair of separate housings 22j each of these housings communicate with one of a pair of longitudinally spaced side apertures 24j, and which carry projecting branching ports 28j, which may be luer connectors if desired, and which may carry needle penetrable, removable rubber closures, as in previous embodiments.

The above has been offered for illustrative purposes only, and is not intended to limit the scope of the invention of this application, which is as defined in the claims below.

That which is claimed is:

1. A rotary valve for a fluid flow line, which comprises:
a valve tube having at least one lumen for unobstructed, fluid flow of the fluid flow line therethrough, said valve tube having at least one side aperture communicating with said lumen; and
a housing which is sealingly and rotatably mounted on the exterior of said valve tube, said housing defining at least one lateral port which registers with said side aperture in a first rotational position of said housing, said lateral port being sealingly and rotationally spaced from said side aperture in a second rotational position of said housing;
further in which said lateral port communicates with an outwardly extending branching port carried on said housing, and said valve tube carries a hinged closure cap positioned to close said branching port when said port member is positioned in said second rotational position.

2. The rotary valve of claim 1 in which said lumen is unobstructed and open in every rotational position of the housing.

3. The rotary valve of claim 2 in which there is only a single lumen, a single side aperture, and a single lateral port present.

4. The rotary valve of claim 2 in which there is only a single lumen, a single side aperture, and a plurality of spaced, lateral ports present.

5. The rotary valve of claim 4 in which said valve tube has a wall which defines a flow channel that communicates between said spaced, lateral ports in one rotational position of said housing, said flow channel being spaced and sealed from said lumen.

6. The rotary valve of claim 1 in which said branching port connects with a third tube in branching relation therewith.

7. The rotary valve of claim 6 in which one of said second and third tubes is a female luer.

8. The rotary valve of claim 7 in which one of said second and third tubes has an outer end that connects with a length of flexible tubing.

9. The rotary valve of claim 1 in which said valve tube defines an abrupt bend along its length.

10. The rotary valve of claim 1 in which said valve tube defines a plurality of separate lumens, each lumen communicating with a separate one of a plurality of said side apertures, whereby said lateral port communicates with each of said side apertures in a different rotational position.

11. The rotary valve of claim 1 in which a plurality of said housings are sealing and separately rotatably mounted on the exterior of said valve tube, each housing communicating in a first rotational position with one of a plurality of said side apertures.

12. The rotary valve of claim 1 in which the branching port comprises a female luer.

13. The rotary valve of claim 2 in which said housing is spring-biased to longitudinally space the lateral port from the side aperture, said housing being manually and longitudinally slideable to permit the housing and the side aperture to register in the first rotational position.

14. A medical fluid flow set which comprises the rotary valve of claim 2, connected in flow relation to opposed lengths of tubing.

15. The rotary valve of claim 2 in which said valve tube is made of generally rigid material, and the housing is made of a more resilient material than that of the valve tube.

16. The rotary valve of claim 2 in which said at least one lumen is straight.

17. A rotary valve for a fluid flow line, which comprises:
a valve tube having at least one lumen for unobstructed, fluid flow of the fluid flow line therethrough, said valve tube having at least one side aperture communicating with said lumen; and
a housing which is sealingly and rotatably mounted on the exterior of said valve tube, said housing defining at least one lateral port which registers with said side aperture in a first rotational position of said tube, said lateral port being sealingly and rotationally spaced from said side aperture in a second rotational position of said housing;
a branching port comprising a female luer connecting with said lateral port and carried by said housing, said female luer having an outer end that is closed by a needle pierceable, resealable rubber closure, said rubber closure being manually removable, whereby substantially aseptic connection may be made with said female luer by either a male luer or a hollow needle.

18. The rotary valve of claim 17 in which said valve tube is made of a generally rigid material and the housing is made of a more resilient material than the material of said valve tube.

19. A medical fluid flow set which comprises the rotary branch valve of claim 17, connected in flow relation to opposed lengths of flexible tubing.

20. The rotary valve of claim 17 in which there is only a single lumen, a single side aperture, and a single lateral port present.

21. The rotary valve of claim 17 in which there is only a single lumen, and a plurality of spaced, lateral ports present.

22. The rotary valve of claim 21 in which said valve tube has a wall which defines a flow channel that communicates between said spaced lateral ports in one rotational position of said housing, said flow channel being spaced and sealed from said lumen.

23. The rotary valve of claim 17 in which said housing is spring-biased to longitudinally space the lateral port from the side aperture, said housing being manually and longitudinally slideable to permit the housing and the side aperture to register in the first rotational position.

24. The rotary valve of claim 17 in which said branching port connects with a third tube in branching relation therewith.

25. The rotary valve of claim 19 in which one of said second and third tubes has an outer end that connects with a length of flexible tubing.

26. The rotary valve of claim 17 in which said valve tube defines an abrupt bend along its length.

27. The rotary valve of claim 17 in which said valve tube defines a plurality of separate lumens, each lumen communicating with a separate one of a plurality of said side apertures, whereby said lateral port communicates with each of said side apertures in a different rotational position.

28. The rotary valve of claim 17 in which a plurality of said housings are sealing and separately rotatably mounted on the exterior of said valve tube, each housing communicating in a first rotational position with one of a plurality of said side apertures.

29. The rotary valve of claim 17 in which said housing carries a projecting handle to facilitate rotation thereof.

30. The rotary valve of claim 1 in which said housing carries a projecting handle to facilitate rotation thereof.

31. The rotary valve of claim 17 in which said rubber closure carries an outwardly projecting tab to facilitate removal.

32. A valve for a fluid flow line, which comprises:
a valve tube having at least one lumen for unobstructed, fluid flow of the fluid flow line therethrough, said valve tube having at least one side aperture communicating with said lumen; and
a housing which is sealingly and rotatably mounted on the exterior of said valve tube, said housing defining at least one lateral port which registers with said side aperture in a first longitudinal sliding position of said housing, said lateral port being sealingly and longitudinally spaced from said side aperture in a second longitudinal position of said housing.

33. The valve of claim 32 in which said housing is spring-biased to longitudinally spaced the lateral port from the side aperture.

34. The valve of claim 32 in which a female luer connects with said lateral port and is carried by said housing, said female luer having an outer end that is closed by a needle pierceable, resealable rubber closure, said rubber closure being manually removable, whereby substantially aseptic connection may be made with said female luer by either a male luer or a hollow needle.
